(19) United States
(12) Patent Application Publication
(10) Pub. No.: US 2025/0142591 A1
(43) Pub. Date: May 1, 2025

(54) PSFCH COVERAGE EXTENSION

(71) Applicant: QUALCOMM Incorporated, San Diego, CA (US)

(72) Inventors: Luanxia YANG, Beijing (CN); Changlong XU, Beijing (CN); Jing SUN, San Diego, CA (US); Xiaoxia ZHANG, San Diego, CA (US); Hao XU, Beijing (CN); Shaozhen GUO, Beijing (CN); Xiaojie WANG, Hillsborough, NJ (US); Siyi CHEN, Beijing (CN)

(21) Appl. No.: 18/833,334

(22) PCT Filed: Mar. 29, 2022
(86) PCT No.: PCT/CN2022/083683

§ 371 Date: Jul. 25, 2024

(51) Int. Cl. H04W 72/25; H04W 72/0446

(52) U.S. Cl. CPC H04W 72/25; H04W 72/0446

(57) ABSTRACT

Methods, apparatuses, and computer-readable medium for sidelink communications may be provided. An example method may include receiving, from a second UE, a sidelink communication. The example method may include transmitting, to the second UE based on the sidelink communication, a physical sidelink feedback channel (PSFCH), the PSFCH spanning multiple symbols in a time domain, including a set of repetitions in a frequency domain, or spanning more than one resource blocks (RBs).

### TECHNICAL FIELD

The present disclosure relates generally to communication systems, and more particularly, to wireless communication systems with physical sidelink feedback channel (PSFCH).

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus at a first user equipment (UE) are provided. The apparatus may receive, from a second UE, a sidelink communication. The apparatus may also transmit, to the second UE based on the sidelink communication, a physical sidelink feedback channel (PSFCH), the PSFCH spanning multiple symbols in a time domain, including a set of repetitions in a frequency domain, or spanning more than one resource blocks (RBs).

To the accomplishment of the foregoing and related ends, the one or more aspects comprise the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2 illustrates example aspects of a sidelink slot structure.

FIG. 3 is a diagram illustrating an example of a first device and a second device involved in wireless communication based, e.g., on sidelink.

FIG. 4 is a diagram illustrating example resources for sidelink communications.

FIG. 5 is a diagram illustrating example communications between two UEs.

FIG. 6 is a diagram illustrating example PSFCH that spans multiple symbols in the time domain.

FIGS. 7A, 7B, and 7C are diagrams illustrating example PSFCH repetitions in the time domain.

FIG. 8 is a diagram illustrating example PSFCH repetitions in the frequency domain.

FIG. 9 is a diagram illustrating example PSFCH repetitions in the frequency domain.

FIG. 10 is a flowchart of a method of wireless communication.

FIG. 11 is a diagram illustrating an example of a hardware implementation for an example apparatus and/or network entity.

### DETAILED DESCRIPTION

Aspects provided herein may provide better signal strength and success rate for PSFCH transmissions.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can comprise a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

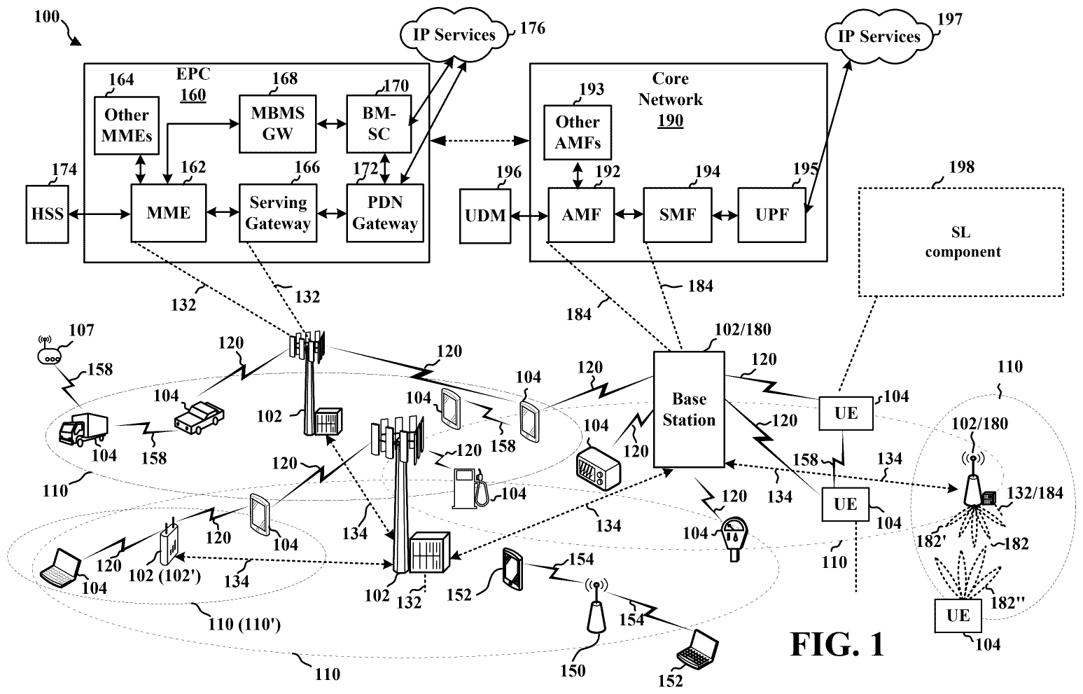

FIG. 1 is a diagram illustrating an example of a wireless communications system and an access network 100. The wireless communications system (also referred to as a wireless wide area network (WWAN)) includes base stations 102, UEs 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

A link between a UE 104 and a base station 102 or 180 may be established as an access link, e.g., using a Uu interface. Other communication may be exchanged between wireless devices based on sidelink. For example, some UEs 104 may communicate with each other directly using a device-to-device (D2D) communication link 158. In some examples, the D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, WiMedia, Bluetooth, ZigBee, Wi-Fi based on the Institute of Electrical and Electronics Engineers (IEEE) 802.11 standard, LTE, or NR.

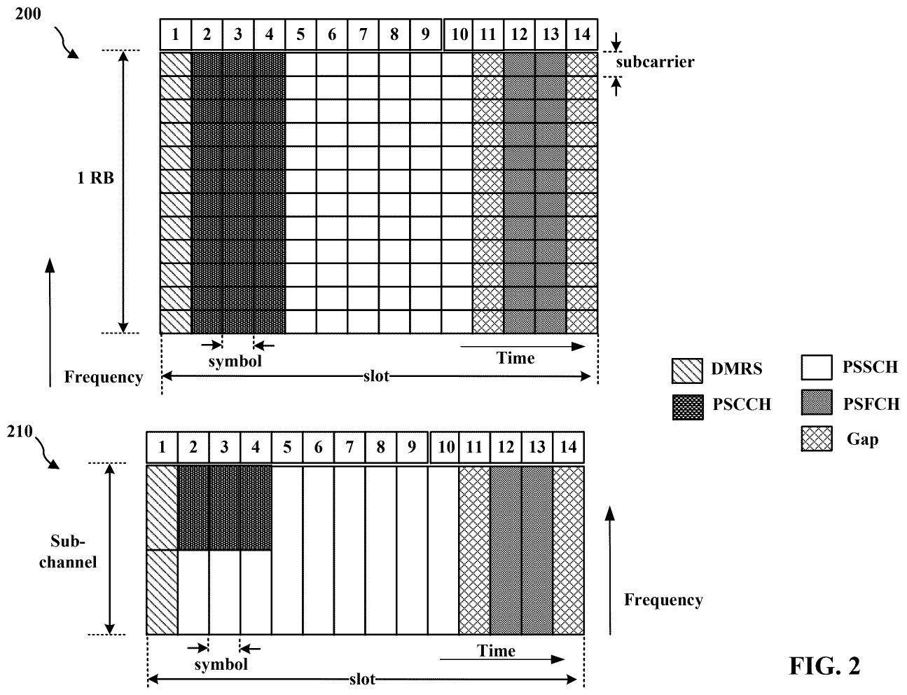

Some examples of sidelink communication may include vehicle-based communication devices that can communicate from vehicle-to-vehicle (V2V), vehicle-to-infrastructure (V2I) (e.g., from the vehicle-based communication device to road infrastructure nodes such as a Road Side Unit (RSU)), vehicle-to-network (V2N) (e.g., from the vehicle-based communication device to one or more network nodes, such as a base station), vehicle-to-pedestrian (V2P), cellular vehicle-to-everything (C-V2X), and/or a combination thereof and/or with other devices, which can be collectively referred to as vehicle-to-anything (V2X) communications. Sidelink communication may be based on V2X or other D2D communication, such as Proximity Services (ProSe), etc. In addition to UEs, sidelink communication may also be transmitted and received by other transmitting and receiving devices, such as Road Side Unit (RSU) 107, etc. Sidelink communication may be exchanged using a PC5 interface, such as described in connection with the example in FIG. 2. Although the following description, including the example slot structure of FIG. 2, may provide examples for sidelink communication in connection with 5G NR, the concepts described herein may be applicable to other similar areas, such as LTE, LTE-A, CDMA, GSM, and other wireless technologies.

Referring again to FIG. 1, in some aspects, the UE 104 may include a SL component 198. In some aspects, the SL component 198 may be configured to receive, from a second UE, a sidelink communication. In some aspects, the SL component 198 may be further configured to transmit, to the second UE based on the sidelink communication, a physical sidelink feedback channel (PSFCH), the PSFCH spanning multiple symbols in a time domain, including a set of repetitions in a frequency domain, or spanning more than one resource blocks (RBs).

The base stations 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., S1 interface). The base stations 102 configured for 5G NR (collectively referred to as Next Generation RAN (NG-RAN)) may interface with core network 190 through second backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or core network 190) with each other over third backhaul links 134 (e.g., X2 interface). The first backhaul links 132, the second backhaul links 184, and the third backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

The wireless communications system may further include a Wi-Fi access point (AP) 150 in communication with Wi-Fi stations (STAs) 152 via communication links 154, e.g., in a 5 GHz unlicensed frequency spectrum or the like. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same unlicensed frequency spectrum (e.g., 5 GHz, or the like) as used by the Wi-Fi AP 150. The small cell 102′, employing NR in an unlicensed frequency spectrum, may boost coverage to and/or increase capacity of the access network.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, FR4, FR4-a or FR4-1, and/or FR5, or may be within the EHF band.

A base station 102, whether a small cell 102′ or a large cell (e.g., macro base station), may include and/or be referred to as an eNB, gNodeB (gNB), or another type of base station. Some base stations, such as gNB 180 may operate in a traditional sub 6 GHz spectrum, in millimeter wave frequencies, and/or near millimeter wave frequencies in communication with the UE 104. When the gNB 180 operates in millimeter wave or near millimeter wave frequencies, the gNB 180 may be referred to as a millimeter wave base station. The millimeter wave base station 180 may utilize beamforming 182 with the UE 104 to compensate for the path loss and short range. The base station 180 and the UE 104 may each include a plurality of antennas, such as antenna elements, antenna panels, and/or antenna arrays to facilitate the beamforming. Similarly, beamforming may be applied for sidelink communication, e.g., between UEs.

The base station 180 may transmit a beamformed signal to the UE 104 in one or more transmit directions 182′. The UE 104 may receive the beamformed signal from the base station 180 in one or more receive directions 182″. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same. Although this example is described for the base station 180 and UE 104, the aspects may be similarly applied between a first and second device (e.g., a first and second UE) for sidelink communication.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include an Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a Packet Switch (PS) Streaming (PSS) Service, and/or other IP services.

The base station may include and/or be referred to as a gNB, Node B, eNB, an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

FIG. 2 includes diagrams 200 and 210 illustrating example aspects of slot structures that may be used for sidelink communication (e.g., between UEs 104, RSU 107, etc.). The slot structure may be within a 5G/NR frame structure in some examples. In other examples, the slot structure may be within an LTE frame structure. Although the following description may be focused on 5G NR, the concepts described herein may be applicable to other similar areas, such as LTE, LTE-A, CDMA, GSM, and other wireless technologies. The example slot structure in FIG. 2 is merely one example, and other sidelink communication may have a different frame structure and/or different channels for sidelink communication. A frame (10 ms) may be divided into 10 equally sized subframes (1 ms). Each subframe may include one or more time slots. Subframes may also include mini-slots, which may include 7, 4, or 2 symbols. Each slot may include 7 or 14 symbols, depending on the slot configuration. For slot configuration 0, each slot may include 14 symbols, and for slot configuration 1, each slot may include 7 symbols. Diagram 200 illustrates a single resource block of a single slot transmission, e.g., which may correspond to a 0.5 ms transmission time interval (TTI). A physical sidelink control channel may be configured to occupy multiple physical resource blocks (PRBs), e.g., 10, 12, 15, 20, or 25 PRBs. The PSCCH may be limited to a single sub-channel. A PSCCH duration may be configured to be 2 symbols or 3 symbols, for example. A sub-channel may include 10, 15, 20, 25, 50, 75, or 100 PRBs, for example. The resources for a sidelink transmission may be selected from a resource pool including one or more subchannels. As a non-limiting example, the resource pool may include between 1-27 subchannels. A PSCCH size may be established for a resource pool, e.g., as between 10-100% of one subchannel for a duration of 2 symbols or 3 symbols. The diagram 210 in FIG. 2 illustrates an example in which the PSCCH occupies about 50% of a subchannel, as one example to illustrate the concept of PSCCH occupying a portion of a subchannel. The physical sidelink shared channel (PSSCH) occupies at least one subchannel. The PSCCH may include a first portion of sidelink control information (SCI), and the PSSCH may include a second portion of SCI in some examples.

A resource grid may be used to represent the frame structure. Each time slot may include a resource block (RB) (also referred to as physical RBs (PRBs)) that extends 12 consecutive subcarriers. The resource grid is divided into multiple resource elements (REs). The number of bits carried by each RE depends on the modulation scheme. As illustrated in FIG. 2, some of the REs may include control information in PSCCH and some REs may include demodulation RS (DMRS). At least one symbol may be used for feedback. FIG. 2 illustrates examples with two symbols for a physical sidelink feedback channel (PSFCH) with adjacent gap symbols. A symbol prior to and/or after the feedback may be used for turnaround between reception of data and transmission of the feedback. The gap enables a device to switch from operating as a transmitting device to prepare to operate as a receiving device, e.g., in the following slot. Data may be transmitted in the remaining REs, as illustrated. The data may include the data message described herein. The position of any of the data, DMRS, SCI, feedback, gap symbols, and/or LBT symbols may be different than the example illustrated in FIG. 2. Multiple slots may be aggregated together in some aspects.

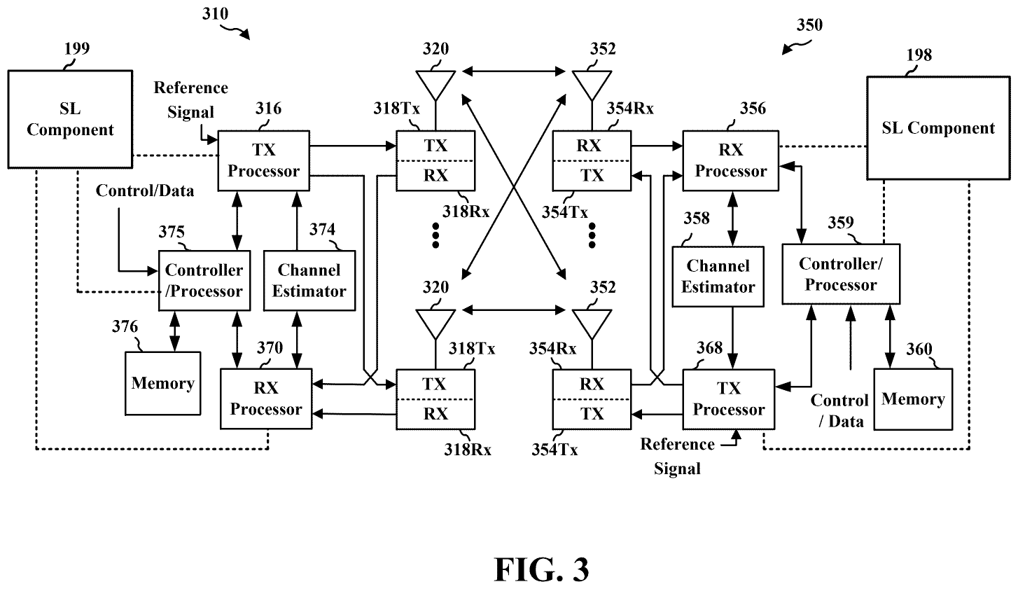

FIG. 3 is a block diagram of a first wireless communication device 310 in communication with a second wireless communication device 350 based on sidelink. In some examples, the devices 310 and 350 may communicate based on V2X or other D2D communication. The communication may be based on sidelink using a PC5 interface. The devices 310 and the 350 may include a UE, an RSU, a base station, etc. Packets may be provided to a controller/processor 375 that implements layer 3 and layer 2 functionality. Layer 3 includes a radio resource control (RRC) layer, and layer 2 includes a packet data convergence protocol (PDCP) layer, a radio link control (RLC) layer, and a medium access control (MAC) layer.

In the SL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the device 350. Each spatial stream may then be provided to a different antenna 320 via a separate transmitter 318Tx. Each transmitter 318Tx may modulate a radio frequency (RF) carrier with a respective spatial stream for transmission.

At the device 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the device 350. If multiple spatial streams are destined for the device 350, they may be combined by the RX processor 356 into a single OFDM symbol stream. The RX processor 356 then converts the OFDM symbol stream from the time-domain to the frequency domain using a Fast Fourier Transform (FFT). The frequency domain signal may include a separate OFDM symbol stream for each subcarrier of the OFDM signal. The symbols on each subcarrier, and the reference signal, are recovered and demodulated by determining the most likely signal constellation points transmitted by the device 310. These soft decisions may be based on channel estimates computed by the channel estimator 358. The soft decisions are then decoded and deinterleaved to recover the data and control signals that were originally transmitted by the device 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the SL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the SL transmission by the device 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the device 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The SL transmission is processed at the device 310 in a manner similar to that described in connection with the receiver function at the device 350. Each receiver 318Rx receives a signal through its respective antenna 320. Each receiver 318Rx recovers information modulated onto an RF carrier and provides the information to a RX processor 370.

The controller/processor 375 can be associated with a memory 376 that stores program codes and data. The memory 376 may be referred to as a computer-readable medium. In the SL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the SL component 198 of FIG. 1.

At least one of the TX processor 316, the RX processor 370, and the controller/processor 375 may be configured to perform aspects in connection with the SL component 199 that may transmit, to a second UE, a sidelink communication and transmit, from the second UE based on the sidelink communication, a physical sidelink feedback channel (PSFCH), the PSFCH spanning multiple symbols in a time domain, including a set of repetitions in a frequency domain, or spanning more than one resource blocks (RBs).

In sidelink communication, a UE may transmit a sidelink transmission, e.g., comprising a control channel (e.g., PSCCH) and/or a corresponding data channel (e.g., PSSCH), that may be received by one or more UEs, e.g., as a unicast, a groupcast or multicast, or a broadcast. A control channel may include information (e.g., sidelink control information (SCI)) for decoding the data channel including reservation information, such as information about time and/or frequency resources that are reserved for the data channel transmission. For example, the SCI may indicate a number of TTIs, as well as the RBs that will be occupied by the data transmission.

Sidelink communication may be based on different types or modes of resource allocation mechanisms. In a first resource allocation mode (which may be referred to herein as “Mode 1”), centralized resource allocation may be provided by a network entity. For example, a base station 102 or 180 may determine resources for sidelink communication and may allocate resources to different UEs 104 to use for sidelink transmissions. In this first mode, a UE receives the allocation of sidelink resources from the base station 102 or 180. In a second resource allocation mode (which may be referred to herein as “Mode 2”), distributed resource allocation may be provided. In Mode 2, each UE may autonomously determine resources to use for sidelink transmission. In order to coordinate the selection of sidelink resources by individual UEs, each UE may use a sensing technique to monitor for resource reservations by other sidelink UEs and may select resources for sidelink transmissions from unreserved resources. Devices communicating based on sidelink, may determine one or more radio resources in the time and frequency domain that are used by other devices in order to select transmission resources that avoid collisions with other devices. The sidelink transmission and/or the resource reservation may be periodic or aperiodic, where a UE may reserve resources for transmission in a current slot and up to two future slots (discussed below).

In some wireless communication systems, sidelink (SL) communications may utilize a 6 GHz band including 5.9 GHz to >7 GHz. In some aspects, depending on device type, UEs may use different frequency operating bands. Table 1 shows examples of different operating bands for sidelink communication by different types of devices.

TABLE 1

| | Operating | Maximum | Maximum | |
|---|---|---|---|---|
| Device Class | bands | EIRP | EIRP PSD | |
| Standard-Power | U-NII-5 (5.925- | 36 dBm | 23 | dBm/MHz |
| Access Point | 6.425 GHz) | | | |
| (AFC Controlled) | U-NII-7 (6.525- | | | |
| Client Connected to | 6.875 GHz) | 30 dBm | 17 | dBm/MHz |
| Standard-Power | | | | |
| Access Point | | | | |
| Low-Power Access | U-NII-5 (5.925- | 30 dBm | 5 | dBm/MHz |
| Point | 6.425 GHz) | | | |
| (indoor only) | U-NII-6 (6.425- | | | |
| Client Connected to | 6.525 GHz) | 24 dBm | −1 | dBm/MHz |
| Low-Power Access | U-NII-7 (6.525- | | | |
| Point | 6.875 GHz) | | | |
| | U-NII-8 (6.875- | | | |
| | 7.125 GHz) | | | |
| Very Low Power | U-NII-5 (5.925- | 4 dBm~14 | −18 dBm/ | |
| Device | 6.425 GHz) | dBm (For a | MHz~−8 | |
| | U-NII-6 (6.425- | 160 MHz | dBm/MHz | |
| | 6.525 GHz) | channel) | | |
| | U-NII-7 (6.525- | | | |
| | 6.875 GHz) | | | |
| | U-NII-8 (6.875- | | | |
| | 7.125 GHz) | | | |

For a SP (standard-power) mode, a base station may communicate with an automated frequency coordination (AFC) to obtain the maximum power spectral density (PSD) or equivalent isotropically radiated power (EIRP) for each frequency. EIRP specifications may be different for different frequencies. If an antenna that is effectively a point source and the antenna radiate RF energy equally in all directions (in three dimensional space), then the signal strength measured at a set distance may be the same regardless of the direction. The antenna may be referred to as radiating “isotropically.” Such an antenna may also be said to have unity gain or no gain. If a non-isotropic or directional antenna is used to measure the signal strength at the same distance (compared with using the isotropic antenna) and the input power was varied to get the same reading, then the radiated power in that specific direction may be equivalent to the isotropic antenna with a given input power. The power that may be radiated by the isotropic antenna to give the equivalent signal strength as the non-directional antenna in the direction of the directional antenna's strongest beam may be the EIRP.

In some aspects, a UE transmission (TX) power may be 6 dB lower than the maximum allowed base station transmit power in both EIRP and PSD (such as 17 dBm/MHz, 30 dBm). The UE may operate under the control of the standard-power access point. For low-power indoor (LPI) mode, a base station may use an LPI mode without communication with the AFC. The UE TX power may also be 6 dB lower than the maximum allowed base station transmit power in both EIRP and PSD (e.g., 1 dBm/MHz, 24 dBm). Both the base station and the associated UEs may employ a contention-based protocol. For very low-power (VLP) mode (which may be in-door or outdoor), devices may operate across the entirety of the 6 GHz band without using an AFC and the TX power may be limited both in PSD and EIRP (e.g., −18 dBm/MHz˜−8 dBm/MHz, 4 dBm˜14 dBm for 160 MHz channel).

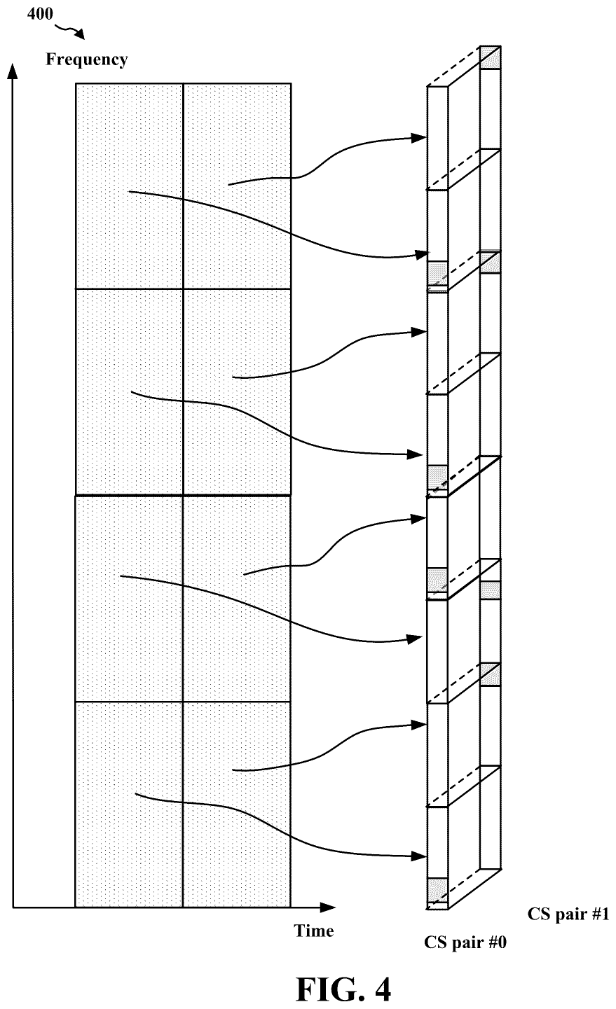

For SL communications, such as a physical sidelink control channel (PSCCH) or physical sidelink shared channel (PSSCH) transmission, the transmitting UE may request an acknowledgment/negative-acknowledgment (ACK/NACK or A/N) for PSSCH. As an example, a UE that is receiving the PSSCH may transmit an ACK in a PSFCH is the PSSCH is accurately received and/or may transmit a NACK in the PSFCH if the PSSCH is not accurately received. PSFCH resource may be from, or associated with, a resource pool configured for multiple UEs, e.g., rather than not from a dedicated PSFCH resource pool. FIG. 4 is a diagram 400 illustrating example resources for sidelink communications. Cyclic shift (CS) pair #1 and CS pair #0 are illustrated. A time period parameter, e.g., periodPSFCHresource, may be provided to a UE and may represent a period in slots for PSFCH transmission in the resource pool. In some examples, the parameter periodPSFCHresource may be 0, 1, 2, or 4 (0 representing no PSFCH, 1 representing 1 slot, 2 representing 2 slots, and 4 representing 4 slots). In some aspects, a PSFCH transmission timing may be the first slot with PSFCH resource after a PSSCH or after a gap (which may be represented by a MinTimeGapPSFCH parameter) after the PSSCH. In some aspects, a set of PRBs in a resource pool for PSFCH in a slot may be configured for the UE and may be represented by a parameter sl-PSFCH-RB-Set, a parameter MPSset may represent the number of resources in the sl-PSFCH-RB-Set. In some aspects, a number of PSSCH slots corresponds to the PSFCH slot may be represented by a parameter N_{PSSCH}^{PSFCH}. In some aspects, each subchannel/slot may have a number of PRBs represented by

$${M}_{subch , slot}^{PSFCH} = \frac{{M}_{PRB , set}^{PSFCH}}{{N}_{PSSCH}^{PSFCH} \times {N}_{subch}} .$$

The parameter N_{subch} may represent a number of subchannels. In some aspects, time first mapping may be used from PSSCH resource to PSFCH PRBs.

A PSFCH resource pool size may be represented by R_{PRB,CS}^{PSFCH} which may be equal to N_{type}^{PSFCH}×N_{CS}^{PSFCH}×M_{subch,slot}^{PSFCH}. The parameter N_{CS}^{PSFCH} is the number of CS pairs, configured per resource pool (the pair may be for A/N, 1 bit). The parameter N_{type}^{PSFCH} is 1 or N_{subchannel}^{PSSCH}, for the subchannels in a PSSCH slot, the PSFCH resource pool may be shared or not. Within the pool, the PSFCH resource may be indexed from PRB index first, then in CS pair index. A PSFCH resource may be determined from the pool based on the PSFCH resource pool size represented by R_{PRB,CS}^{PSFCH} and a physical source identifier (ID) PID from a second stage sidelink control information (SCI) for PSSCH and an M_{ID}, which may represent identity of the UE receiving the PSSCH or 0. In some aspects, PSFCH resource determination may be based on (P_{ID}+M_{ID})mod R_{PRB,CS}^{PSFCH}. In some examples, for unicast or NAK (representing data error) based transmission, M_{ID}=0 and the UE may send A/N or NAK at a source ID dependent resource in the pool.

In some examples, due to PSD specifications, a maximum power for 20 MHz in SL-U LPI mode and VLP mode may not be reached. For example, for the LPI mode in a 6 GHz band, the PSD specification may be −1 dBm per MHz for the UE and a maximum EIRP may be 24 dBm. As a result, the UE may transmit 320 MHz to reach the peak power, which may not be possible. Similarly, for a VLP mode in the 6 GHz band, the PSD specification may be −18 dBm˜−8 dBm per MHz for UE and a maximum EIRP may be 4 dBm˜14 dBm. As a result, the UE may transmit 160 MHz to reach the peak power, which may not be possible. As a result of not reaching the peak power, the signal strength and the success rate for the PSFCH transmission in a 6 GHz frequency may suffer. Aspects provided herein may provide better signal strengths and success rates for PSFCH transmissions. In some aspects, a UE may employ PSFCH repetition in the time domain. In some aspects, a UE may employ PSFCH repetition in the frequency domain. In some aspects, the UE may transmit a PSFCH that spans from one RB to multiple RBs.

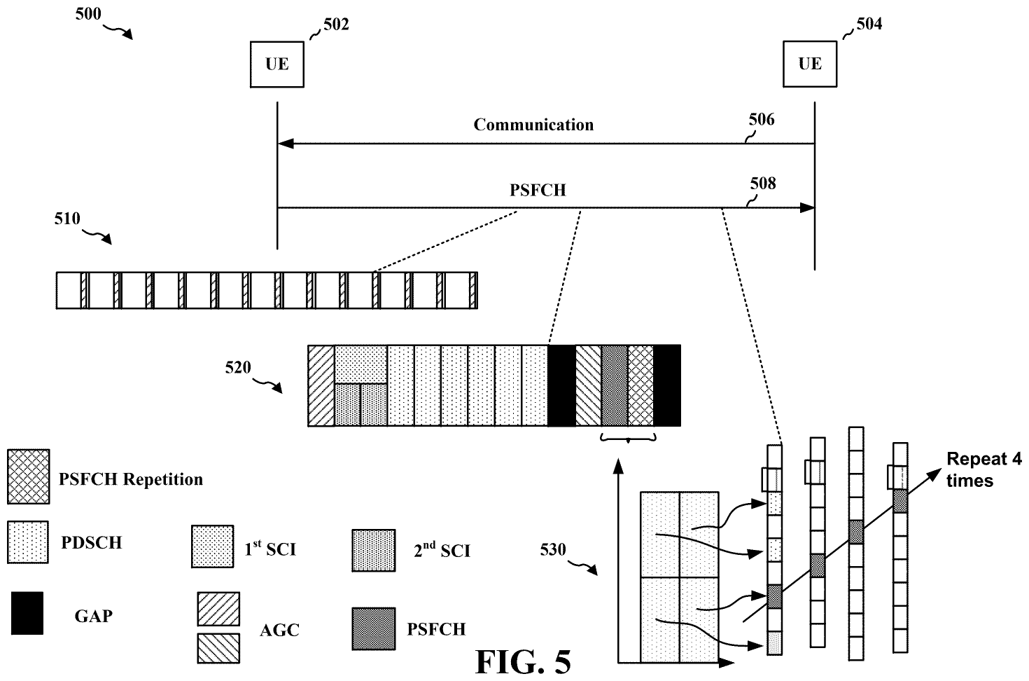

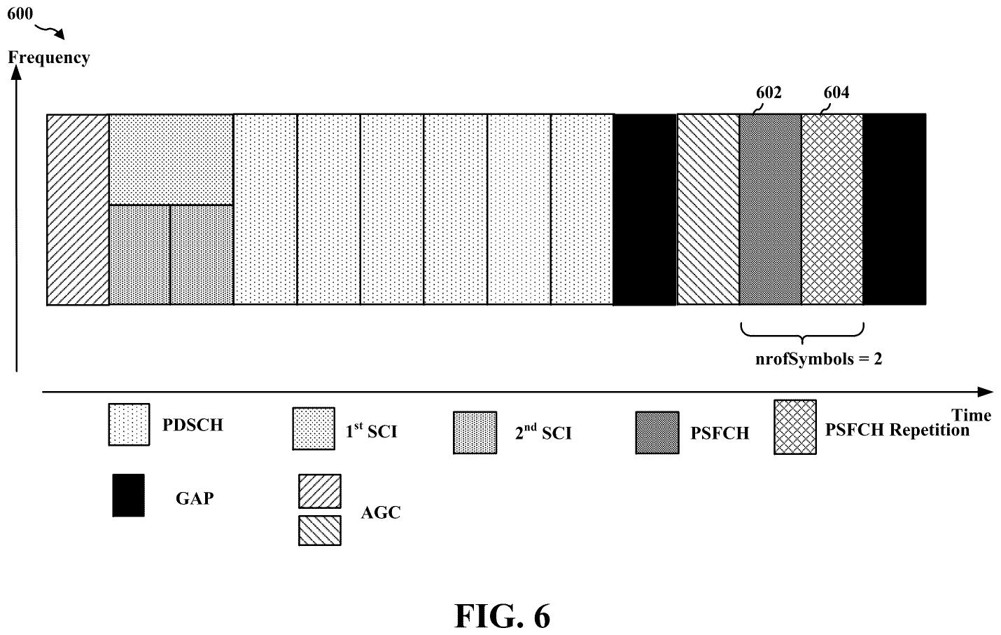

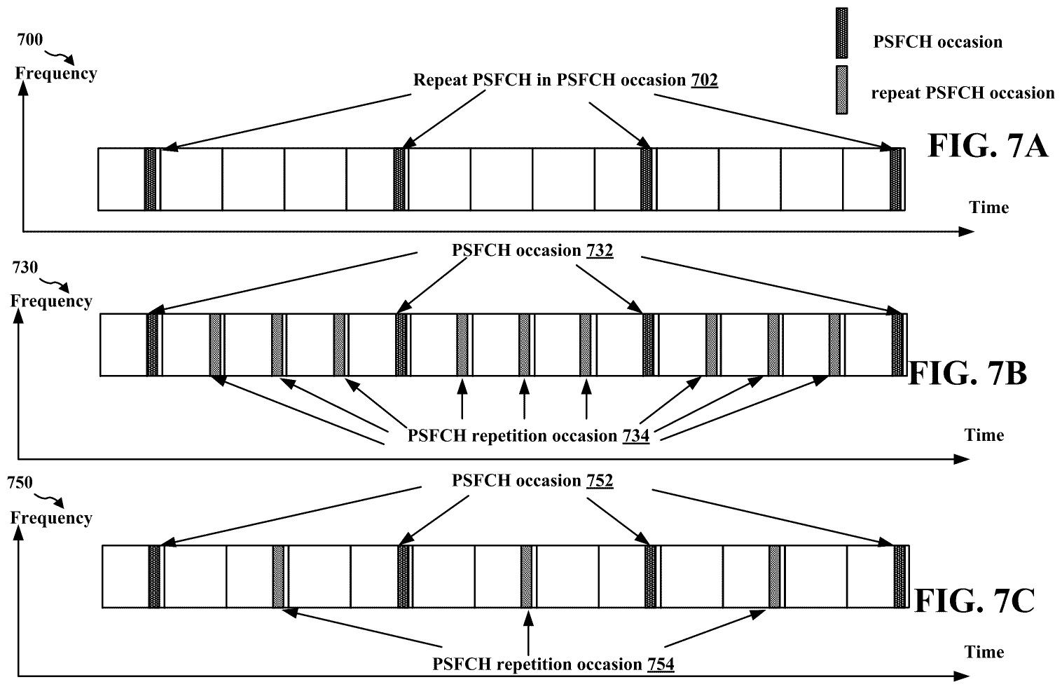

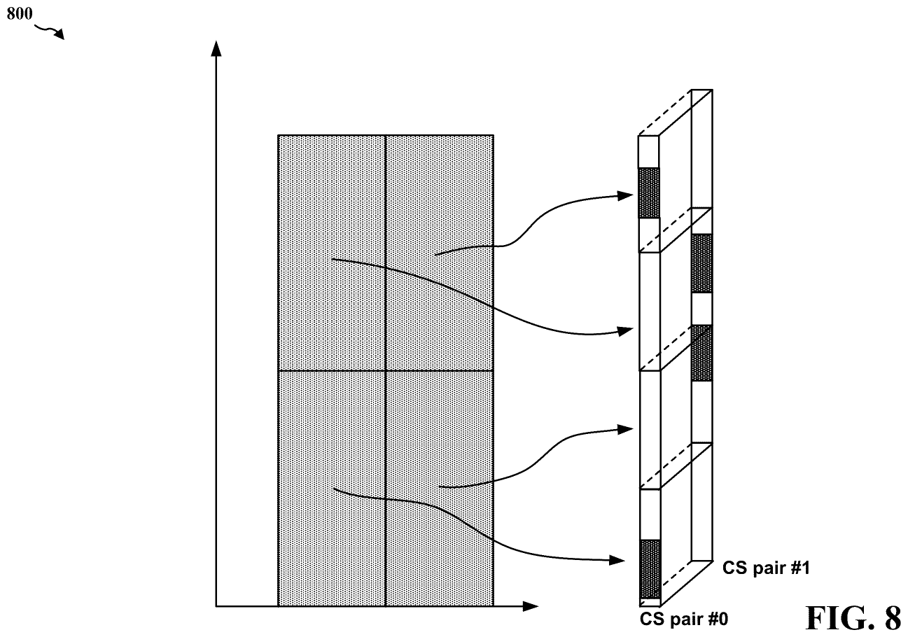

FIG. 5 is a diagram 500 illustrating example communications between two UEs, UE 502 and UE 504. As illustrated in FIG. 5, the UE 502 may receive a sidelink transmission, e.g., communication 506, from the UE 504 and may accordingly transmit a PSFCH 508 to respond. In some aspects, the UE 502 and the UE 504 may operate in a 6 GHz band. The PSFCH 508 may be associated with PSFCH repetition(s) in the time domain (e.g., as shown at 510 or 520), PSFCH repetition(s) in the frequency domain (e.g., as shown at 530), or may span from one RB to multiple RBs as further elaborated in connection with FIG. 6, FIGS. 7A, 7B, and 7C, and FIG. 8.

FIG. 6 is a diagram 600 illustrating example PSFCH that spans multiple symbols in the time domain. As illustrated in FIG. 6, a PSFCH may span from one to multiple symbols in time domain (e.g., symbol 602 and symbol 604). Before the symbol 602, there may be symbol for automatic gain control (AGC). In some aspects, the UE 502 may be configured with a number of symbols for PSFCH resource pool configuration for the PSFCH 508 (represented by a parameter such as nrofSymbols). In some aspects, a defined number, such as a second OFDM symbol l′ of PSFCH transmission in a slot may be defined as l′=startSLsymbols+lengthSLsymbols−(nrofsymbols+1). The parameter startSLsymbols and the parameter lengthSLsymbols may be higher layer parameters. In some aspects, the parameter startSLsymbols may represent a symbol index of a first symbol of a lengthSLsymbols (representing a number of symbols) consecutive symbols configured for sidelink associated with the PSFCH 508. In some aspects, if the PSFCH is transmitted in 2 symbols or in multiple symbols, the second symbol 604, or additional symbols, may be a repetition of the first symbol 602. In some aspects, if the UE transmits 4 or more PSFCH symbols, there may be repetition of 1 symbol PSFCH, or the PSFCH transmission may be based on a format of PUCCH format 1. In some aspects, the PSFCH transmission may be based on a format of PUCCH format 1 to span the PSFCH to multiple symbols. In PUCCH format 1, each UE in the cell may be assigned a specific resource index mapping, a resource which can be used every nth frame to transmit a scheduling request.

FIGS. 7A, 7B, and 7C are diagrams 700, 730, and 750 illustrating example PSFCH repetitions in the time domain. In some aspects, the PSFCH 508 may include repetitions in different slots. A parameter nrofSlots may represent a number of slots for the repetitions. In some aspects, as illustrated in FIG. 7A, for one or more PSFCH repetitions 702, there may be time gap between two PSFCH occasion. In some aspects, the time gap between two PSFCH occasion may be represented by a sl-PSFCH-Period parameter. In some aspects, to avoid collisions (overlapping in time and frequency) with other PSFCH transmissions, a first transmission and repetition occasion of PSFCH may be separated. As one example, a PSFCH occasion for a first occasion of the PSFCH transmission may be based on d.

In some aspects, as illustrated in FIG. 7B, one or more PSFCH occasions 732 and associated repetition occasions 734 may be in back-to-back (consecutive in time) slots. In some aspects, after a PSFCH occasion, the PSFCH may be repeated in a normal slot. In some aspects, the normal slot may leave the symbol for PSFCH collision. In some aspects, a number of normal slots with blanking symbols for the PSFCH repetition may equal to the maximum number of repetition of the resource pool—1. In some aspects, the normal slot may not consider PSFCH repetition. Collision, e.g., an overlap in time and/or frequency, may occur between PSFCH transmissions and PSSCH transmissions by different transmitters.

In some aspects, as illustrated in FIG. 7C, for some PSFCH occasions in one or more PSFCH occasions 752, the associated PSFCH repetition occasion in the one or more PSFCH repetition occasions 754 may be in back-to-back slots. In some aspects, there may be a repetition period between slots and there may be a gap. For example, the period may be 4 slots for two slots with a two slot gap in the middle.

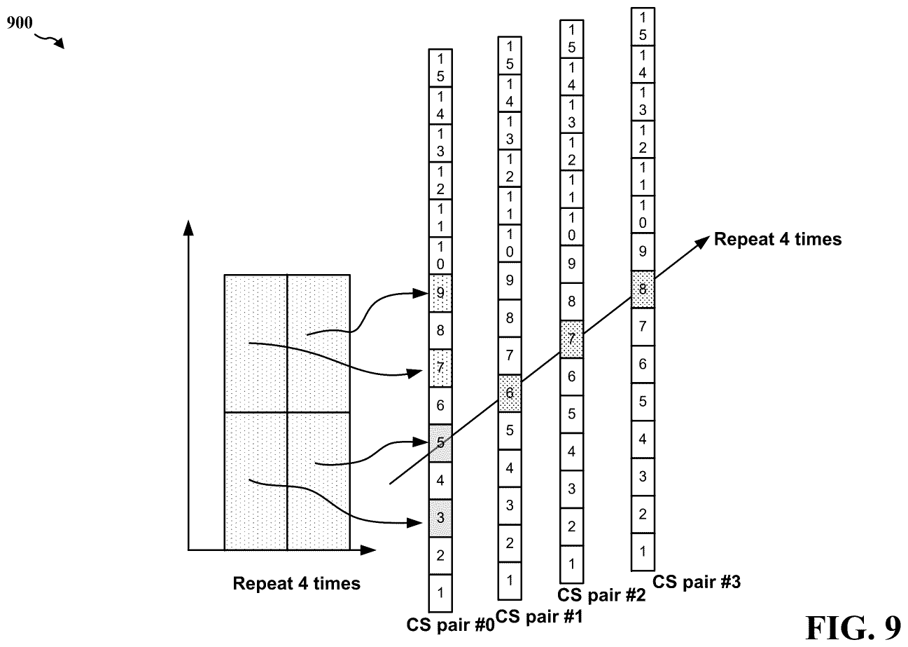

FIG. 8 is a diagram 800 illustrating example PSFCH repetitions in the frequency domain. In some aspects, a SL transmission may schedule more than one RB for the PSFCH 508. In some aspects, the number of PSFCH repetitions in the PSFCH 508 may be based on scheduled resources for the PSFCH. As an example, the number of PSFCH repetitions in the PSFCH may be equal to the number of scheduled RBs for the PSFCH 508. FIG. 9 is a diagram 900 illustrating example PSFCH repetitions in the frequency domain. In some aspects, the RB may be continued for PSFCH and a same transmission may be repeated across different RBs. In some aspects, transmissions on the different RBs may use different cyclic shift. In some aspects, pseudo-noise (PN) sequence-based scrambling may be used for the transmission on the different RBs.

In some aspects, to choose the proper PSFCH resource and reduce collision, the number of RBs for PSFCH selection may be based on a support repetition number for a resource pool. For example, the number of RBs for PSFCH selection may be equal to a maximum supported repetition number X of current resource pool. In some aspects, even the repetition number of one UE (e.g., UE 502) is less than the X, when the UE 502 selects the PSFCH resource, the UE may still select the amount of the PSFCH resources to use for the PSFCH transmission.

In some aspects, the UE may select the PSFCH resource under a different procedure that a number of supported cyclic shift pairs of the resource pool depend on the supported number of repetition. For example, PSFCH resource pool is of size: R_{PRB,CS}^{PSFCH}=N_{type}^{PSFCH}×N_{CS}^{PSFCH}×M_{subch,slot}^{PSFCH}. The parameter N_{CS}^{PSFCH} may represent a number of supported cyclic shift pairs of the resource pool that may be dependent on the number of repetitions and may be equal to

$$⌊ {N}_{CS , legacy}^{PSFCH} / {N}_{repetition} ⌋ .$$

In some aspects, N_{CS,legacy}^{PSFCH} may represent a number of supported cyclic shift pairs. The parameter Nᵣₑₚₑₜᵢₜᵢₒₙ may be the number of PSFCH repetition. For example, the maximum number of N_{CS}^{PSFCH} may be 6, so the maximum value of Nᵣₑₚₑₜᵢₜᵢₒₙ may be 4. If Nᵣₑₚₑₜᵢₜᵢₒₙ is 4, the number of supported cyclic shift pairs for first transmission may be 1. As one example, the supported cyclic shift pairs for the first transmission may be (0,6). For the first repetition, the cyclic shift pairs may be (1,7). For the second repetition, the cyclic shift may be (2,9). For the third repetition, the cyclic shift may be (3,10). In some aspects, the selected RB may be the lowest or highest index for PSFCH RB, and the following ascending or descending RB may be used for PSFCH repetition.

In some aspects, interlaced waveform for the PSFCH 508 may be used. In some aspects, one interlace per one RB set may not be enough, the interlace waveform over multiple RB sets may be introduced. In some aspects, a higher-layer parameter useInterlacePSFCH-PSSCH in Sl-resourcepool may be configured which may indicate interlaced mapping. In some aspects, a cyclic shift αₗ of a PRB may be represented as:

$${α}_{l} = \frac{2 π}{{N}_{SC}^{RB}} ( ( {m}_{0} + {m}_{CS} + {m}_{int} + {n}_{CS} ( {n}_{S , f}^{μ} , l + {l}^{′} ) ) mod {N}_{SC}^{RB} )$$

In some aspects, the parameter n_{s,f}^{μ} may represent the slot number in the radio frame. In some aspects, l may represent the OFDM symbol number in the PSFCH transmission where l=0 corresponds to the first OFDM symbol of the PSFCH transmission. In some aspects, l′ may represent the index of the OFDM symbol in the slot that corresponds to the first OFDM symbol of the PSFCH transmission in the slot. In some aspects, m_{CS} may be a parameter for computing a value of cyclic shift if the UE detects a SCI format 2-A or SCI format 2-B with some cast type indicator. In some aspects, m₀ may be a parameter for computing a value of cyclic shift from a cyclic shift pair index corresponding to a PSFCH resource index and from N_{CS}^{PSFCH} based on a table. In some aspects,

$${m}_{0} = i * \frac{{N}_{RB}^{PSFCH} \cdot {N}_{SC}^{RB}}{2 \cdot {N}_{CS}^{PSFCH}} .$$

In some aspects, when HARQ-ACK information includes ACK or NACK, m_{cs} may be based on:

TABLE 2

| HARQ-ACK Value | 0 (NACK) | 1 (ACK) |
|---|---|---|
| Sequence cyclic shift | 0 | N_{RB}^{PSFCH} · N_{SC}^{RB}/2 |

The parameter mᵢₙₜ may be=5n_{IRB}^{μ} if the PSFCH may use interlaced mapping according to the higher-layer parameter useInterlacePSFCH-PSSCH in SL-ResourcePool (otherwise equal to 0). In some aspects, n_{IRB}^{μ} may represent the resource block number within the interlace. In some aspects, within 12 PRBs of interlaces, because 5 is co-prime with 12, the resulting cyclic shift may not repeat; beyond 12 PRBs, repetitions may occur. In some aspects, m_{RBset} may be added

$${α}_{l} = \frac{2 π}{{N}_{SC}^{RB}} ( ( {m}_{0} + {m}_{CS} + {m}_{int} + {m}_{RBset} + {n}_{CS} ( {n}_{S , f}^{μ} , l + {l}^{′} ) ) mod {N}_{SC}^{RB} ) .$$

In some aspects, m_{RBset}=0 for the first 12 PRBs, and m_{RBset}=2n_{IRB}^{μ}, 6n_{IRB}^{μ}, 8 n_{IRB}^{μ} for every other 12 PRBs. In some aspects, a root sequence change for different 12 RB segments may be introduced.

In some aspects, to choose a PSFCH resource and to reduce collision, a resource pool per RB sets may be provided or configured. For example, if the PSFCH 508 of the UE 502 may occupy 80 MHz, the UE 502 may select PSFCH resources from multiple, e.g., 4, PSFCH resource pools separately. In some aspects, the resource pool may be configured across multiple RB sets. In some aspects, a number of RB sets for the PSFCH selection may be based on the number of supported RB set of a current resource pool. In some aspects, number of RB sets for the PSFCH selection may be equal to a maximum supported RB sets X of current resource pool. In some aspects, the occupied RB sets of the UE 502 may be less than the X, when the UE 502 selects the PSFCH resource, the UE 502 may still select X PSFCH resources. In some aspects, a parameter sl-PSFCH-RBSets indicating resources may be introduced in PSFCH configuration for the UE 502. In some aspects, available PSFCH resources may be:

$${R}_{PRB , SC}^{PSFCH} = {N}_{CS}^{PSFCH} \times 10 / {N}_{PSSCH}^{PSFCH} .$$

In some aspects, the PSFCH 508 may span multiple RBs with a sequence. In some aspects, a radio resource control (RRC) parameter (e.g., nrofRBs) may represent the number of RBs used for the PSFCH 508. In some aspects, a field in a second stage SCI may indicate the number of RBs used for the PSFCH 508. In some aspects, to generate the sequence for the PSFCH 508, the UE may determine the m₀ value, for computing a value of cyclic shift α, from a cyclic shift pair index corresponding to a PSFCH resource index i and from N_{CS}^{PSFCH}.

In some aspects,

$${m}_{0} = i * \frac{{N}_{RB}^{PSFCH} \cdot {N}_{SC}^{RB}}{2 \cdot {N}_{CS}^{PSFCH}} .$$

In some aspects, when HARQ-ACK information includes ACK or NACK, m_{cs} may be based on:

TABLE 3

| HARQ-ACK Value | 0 (NACK) | 1 (ACK) |
|---|---|---|
| Sequence cyclic shift | 0 | N_{RB}^{PSFCH} · N_{SC}^{RB}/2 |

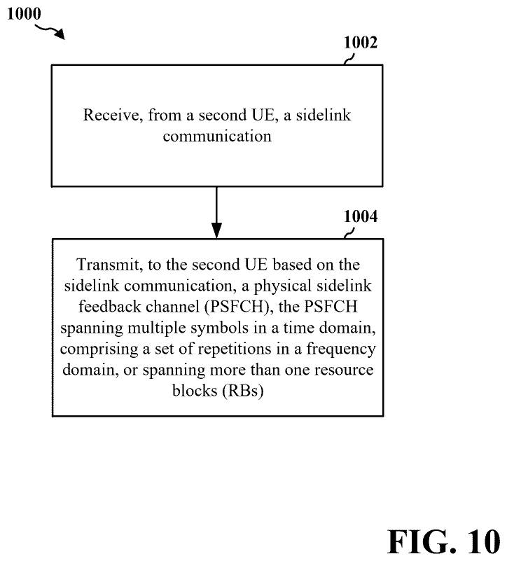

FIG. 10 is a flowchart 1000 of a method of wireless communication. The method may be performed by a UE (e.g., the UE 104, the UE 502; the apparatus 1104).

At 1002, the UE may receive, from a second UE, a sidelink communication. For example, the UE 502 may receive, from a second UE 504, a sidelink communication 506. In some aspects, 1002 may be performed by the SL component 198.

At 1004, the UE may transmit, to the second UE based on the sidelink communication, a PSFCH, the PSFCH spanning multiple symbols in a time domain, including a set of repetitions in a frequency domain, or spanning more than one RBs. For example, the UE 502 may transmit, to the second UE 504 based on the sidelink communication 506, a PSFCH 508. As described in connection with FIG. 6, FIGS. 7A, 7B, and 7C, and FIG. 8, the PSFCH may be spanning multiple symbols in a time domain, including a set of repetitions in a frequency domain, or spanning more than one RBs. In some aspects, 1004 may be performed by the SL component 198. In some aspects, the PSFCH spans the multiple symbols in the time domain and includes a second set of repetitions in one slot. In some aspects, the PSFCH may be associated with a parameter indicating a starting symbol associated with the second set of repetitions. In some aspects, a number of PSFCH symbols associated with the PSFCH may be two, and the starting symbol associated with the second set of repetitions may be a second symbol associated with the PSFCH. In some aspects, a number of PSFCH symbols associated with the PSFCH may be four or more, and the second set of repetitions may include one or more one symbol repetitions.

In some aspects, the PSFCH spans the multiple symbols in the time domain and may include a second set of repetitions in two or more slots. In some aspects, each PSFCH occasion in the second set of repetitions may be separated by a time gap. In some aspects, each PSFCH occasion in the second set of repetitions may be consecutive with another PSFCH occasion in the second set of repetitions. In some aspects, a time duration associated with the second set of repetitions may include one or more time gaps, a number of the one or more time gaps being unequal to a number of repetitions in the second set of repetitions.

In some aspects, the PSFCH may include the set of repetitions in the frequency domain, and where a number of repetitions associated with the set of repetitions in the frequency domain may be equal to a number of scheduled RBs associated with the PSFCH. In some aspects, the set of repetitions spans the more than one RBs, and where each RB in the more than one RBs may be associated with a different cyclic shift. In some aspects, the set of repetitions spans the more than one RBs, and where each repetition in the set of repetitions may be associated with a pseudo-noise (PN) sequence-based scrambling. In some aspects, the set of repetitions may be associated with one or more interlaced waveforms. In some aspects, the one or more interlaced waveforms may be associated with one or more cyclic shifts defined based on a higher layer parameter associated with the one or more interlaced waveforms. In some aspects, the one or more cyclic shifts may be defined further based on a parameter based on the number of scheduled RBs associated with the PSFCH. In some aspects, the one or more cyclic shifts are associated with a root sequence change.

In some aspects, a resource pool may be defined for each RB of the more than one RBs. In some aspects, a single resource pool may be defined for all of the more than one RBs. In some aspects, the PSFCH spans the more than one resource blocks (RBs), and where a number associated with the more than one RBs may be defined based on a radio resource control (RRC) parameter. In some aspects, the PSFCH spans the more than one resource blocks (RBs), and where a number associated with the more than one RBs may be defined based on a parameter in a sidelink control information (SCI) associated with the PSFCH. In some aspects, the PSFCH spans the more than one resource blocks (RBs) with a sequence, and where the sequence may be generated based on a cyclic shift, a cyclic shift pair index corresponding to a PSFCH resource index associated with the PSFCH.

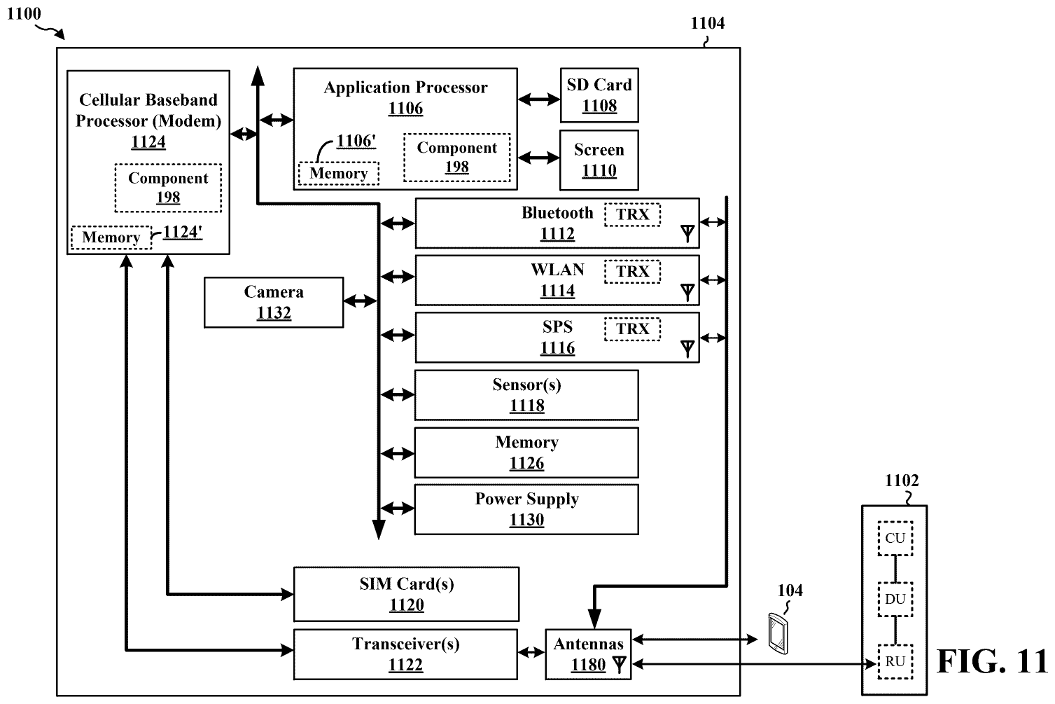

FIG. 11 is a diagram 1100 illustrating an example of a hardware implementation for an apparatus 1104. The apparatus 1104 may be a UE, a component of a UE, or may implement UE functionality. In some aspects, the apparatus 1104 may include a cellular baseband processor 1124 (also referred to as a modem) coupled to one or more transceivers 1122 (e.g., cellular RF transceiver). The cellular baseband processor 1124 may include on-chip memory 1124′. In some aspects, the apparatus 1104 may further include one or more subscriber identity modules (SIM) cards 1120 and an application processor 1106 coupled to a secure digital (SD) card 1108 and a screen 1110. The application processor 1106 may include on-chip memory 1106′. In some aspects, the apparatus 1104 may further include a Bluetooth module 1112, a WLAN module 1114, a satellite system module 1116 (e.g., GNSS module), one or more sensor modules 1118 (e.g., barometric pressure sensor/altimeter; motion sensor such as inertial management unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1126, a power supply 1130, and/or a camera 1132. The Bluetooth module 1112, the WLAN module 1114, and the satellite system module 1116 may include an on-chip transceiver (TRX)/receiver (RX). The cellular baseband processor 1124 communicates through the transceiver(s) 1122 via one or more antennas 1180 with the UE 104 and/or with an RU associated with a network entity 1102. The cellular baseband processor 1124 and the application processor 1106 may each include a computer-readable medium/memory 1124′, 1106′, respectively. The additional memory modules 1126 may also be considered a computer-readable medium/memory. Each computer-readable medium/memory 1124′, 1106′, 1126 may be non-transitory. The cellular baseband processor 1124 and the application processor 1106 are each responsible for general processing, including the execution of software stored on the computer-readable medium/memory. The software, when executed by the cellular baseband processor 1124/application processor 1106, causes the cellular baseband processor 1124/application processor 1106 to perform the various functions described supra. The computer-readable medium/memory may also be used for storing data that is manipulated by the cellular baseband processor 1124/application processor 1106 when executing software. The cellular baseband processor 1124/application processor 1106 may be a component of the device 350 and may include the memory 360 and/or at least one of the TX processor 368, the RX processor 356, and the controller/processor 359. In one configuration, the apparatus 1104 may be a processor chip (modem and/or application) and include just the cellular baseband processor 1124 and/or the application processor 1106, and in another configuration, the apparatus 1104 may be the entire UE and include the additional modules of the apparatus 1104.

As discussed supra, the component 198 is configured to receive, from a second UE, a sidelink communication and transmit, to the second UE based on the sidelink communication, a physical sidelink feedback channel (PSFCH), the PSFCH spanning multiple symbols in a time domain, including a set of repetitions in a frequency domain, or spanning more than one resource blocks (RBs). The component 198 may be within the cellular baseband processor 1124, the application processor 1106, or both the cellular baseband processor 1124 and the application processor 1106. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. As shown, the apparatus 1104 may include a variety of components configured for various functions. In one configuration, the apparatus 1104, and in particular the cellular baseband processor 1124 and/or the application processor 1106, includes means for receiving, from a second UE, a sidelink communication and means for transmitting, to the second UE based on the sidelink communication, a physical sidelink feedback channel (PSFCH), the PSFCH spanning multiple symbols in a time domain, including a set of repetitions in a frequency domain, or spanning more than one resource blocks (RBs).

The means may be the component 198 of the apparatus 1104 configured to perform the functions recited by the means. As described supra, the apparatus 1104 may include the TX processor 368, the RX processor 356, and the controller/processor 359. As such, in one configuration, the means may be the TX processor 368, the RX processor 356, and/or the controller/processor 359 configured to perform the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. If a first apparatus receives data from or transmits data to a second apparatus, the data may be received/transmitted directly between the first and second apparatuses, or indirectly between the first and second apparatuses through a set of apparatuses. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used in this disclosure outside of the claims, the phrase “based on” is inclusive of all interpretations and shall not be limited to any single interpretation unless specifically recited or indicated as such. For example, the phrase “based on A” (where “A” may be information, a condition, a factor, or the like) may be interpreted as: “based at least on A,” “based in part on A,” “based at least in part on A,” “based only on A,” or “based solely on A.” Accordingly, as disclosed herein, “based on A” may, in one aspect, refer to “based at least on A.” In another aspect, “based on A” may refer to “based in part on A.” In another aspect, “based on A” may refer to “based at least in part on A.” In another aspect, “based on A” may refer to “based only on A.” In another aspect, “based on A” may refer to “based solely on A.” In another aspect, “based on A” may refer to any combination of interpretations in the alternative. As used in the claims, the phrase “based on A” shall be interpreted as “based at least on A” unless specifically recited differently.

The following aspects are illustrative only and may be combined with other aspects or teachings described herein, without limitation.

Aspect 1 is a method for communication at a first user equipment (UE), including: receiving, from a second UE, a sidelink communication; and transmitting, to the second UE based on the sidelink communication, a physical sidelink feedback channel (PSFCH), the PSFCH spanning multiple symbols in a time domain, including a set of repetitions in a frequency domain, or spanning more than one resource blocks (RBs).

Aspect 2 is the method of aspect 1, where the PSFCH spans the multiple symbols in the time domain and includes a second set of repetitions in one slot.

Aspect 3 is the method of aspect 2, where the PSFCH is associated with a parameter indicating a starting symbol associated with the second set of repetitions.

Aspect 4 is the method of any of aspects 2-3, where a number of PSFCH symbols associated with the PSFCH is two, and the starting symbol associated with the second set of repetitions is a second symbol associated with the PSFCH.

Aspect 5 is the method of any of aspect 2-4, where a number of PSFCH symbols associated with the PSFCH is four or more, and the second set of repetitions includes one or more one symbol repetitions.

Aspect 6 is the method of any of aspect 1-5, where a number of PSFCH symbols associated with the PSFCH is four or more, and the PSFCH spans multiple symbols.

Aspect 7 is the method of any of aspect 1-6, where the PSFCH spans the multiple symbols in the time domain and includes a second set of repetitions in two or more slots.

Aspect 8 is the method of any of aspect 1-7, where each PSFCH occasion in the second set of repetitions is separated by a time gap.

Aspect 9 is the method of any of aspect 1-7, where each PSFCH occasion in the second set of repetitions is consecutive with another PSFCH occasion in the second set of repetitions.

Aspect 10 is the method of any of aspect 1-7, where a time duration associated with the second set of repetitions includes one or more time gaps, a number of the one or more time gaps being unequal to a number of repetitions in the second set of repetitions.

Aspect 11 is the method of any of aspect 1-10, where the PSFCH includes the set of repetitions in the frequency domain, and where a number of repetitions associated with the set of repetitions in the frequency domain is equal to a number of scheduled RBs associated with the PSFCH.

Aspect 12 is the method of any of aspect 1-11, where the set of repetitions spans the more than one RBs, and where each RB in the more than one RBs is associated with a different cyclic shift.

Aspect 13 is the method of any of aspect 1-12, where the set of repetitions spans the more than one RBs, and where each repetition in the set of repetitions is associated with a pseudo-noise (PN) sequence-based scrambling.

Aspect 14 is the method of any of aspect 1-13, where the set of repetitions is associated with one or more interlaced waveforms.

Aspect 15 is the method of any of aspect 1-14, where the one or more interlaced waveforms is associated with one or more cyclic shifts defined based on a higher layer parameter associated with the one or more interlaced waveforms.

Aspect 16 is the method of any of aspect 1-15, where the one or more cyclic shifts is defined further based on a parameter based on the number of scheduled RBs associated with the PSFCH.

Aspect 17 is the method of any of aspect 1-16, where the one or more cyclic shifts are associated with a root sequence change.

Aspect 18 is the method of any of aspect 1-17, where a resource pool is defined for each RB of the more than one RBs.

Aspect 19 is the method of any of aspect 1-17, where a single resource pool is defined for all of the more than one RBs.

Aspect 20 is the method of any of aspect 1-19, where a number of cyclic shift pair associated with the PSFCH is based on the number of repetitions associated with the set of repetitions in the frequency domain.

Aspect 21 is the method of any of aspect 1-20, where the PSFCH spans the more than one resource blocks (RBs), and where a number associated with the more than one RBs is defined based on a radio resource control (RRC) parameter.

Aspect 22 is the method of any of aspect 1-21, where the PSFCH spans the more than one resource blocks (RBs), and where a number associated with the more than one RBs is defined based on a parameter in a sidelink control information (SCI) associated with the PSFCH.

Aspect 23 is the method of any of aspect 1-22, where the PSFCH spans the more than one resource blocks (RBs) with a sequence, and where the sequence is generated based on a cyclic shift, a cyclic shift pair index corresponding to a PSFCH resource index associated with the PSFCH.

Aspect 24 is an apparatus for wireless communication at a network entity including a memory and at least one processor coupled to the memory and, based at least in part on information stored in the memory, configured to perform a method in accordance with any of aspects 1-23. The apparatus may include at least one of a transceiver or an antenna coupled to the at least one processor.

Aspect 25 is an apparatus for wireless communications, including means for performing a method in accordance with any of aspects 1-23.

Aspect 26 is a non-transitory computer-readable medium including instructions that, when executed by an apparatus, cause the apparatus to perform a method in accordance with any of aspects 1-23.

What is claimed is:

1. An apparatus for communication at a first user equipment (UE), comprising:
memory; and
at least one processor coupled to the memory and, based at least in part on information stored in the memory, the at least one processor is configured to:
receive, from a second UE, a sidelink communication; and
transmit, to the second UE based on the sidelink communication, a physical sidelink feedback channel (PSFCH), the PSFCH spanning multiple symbols in a time domain, comprising a set of repetitions in a frequency domain, or spanning more than one resource blocks (RBs).

2. The apparatus of claim 1, wherein the PSFCH spans the multiple symbols in the time domain and comprises a second set of repetitions in one slot.

3. The apparatus of claim 2, wherein the PSFCH is associated with a parameter indicating a starting symbol associated with the second set of repetitions.

4. The apparatus of claim 3, wherein a number of PSFCH symbols associated with the PSFCH is two, and the starting symbol associated with the second set of repetitions is a second symbol associated with the PSFCH.

5. The apparatus of claim 3, wherein a number of PSFCH symbols associated with the PSFCH is four or more, and the second set of repetitions comprises one or more one symbol repetitions.

6. The apparatus of claim 1, wherein a number of PSFCH symbols associated with the PSFCH is four or more, and the PSFCH spans multiple symbols.

7. The apparatus of claim 1, wherein the PSFCH spans the multiple symbols in the time domain and comprises a second set of repetitions in two or more slots.

8. The apparatus of claim 7, wherein each PSFCH occasion in the second set of repetitions is separated by a time gap.

9. The apparatus of claim 7, wherein each PSFCH occasion in the second set of repetitions is consecutive with another PSFCH occasion in the second set of repetitions.

10. The apparatus of claim 7, wherein a time duration associated with the second set of repetitions comprises one or more time gaps, a number of the one or more time gaps being unequal to a number of repetitions in the second set of repetitions.

11. The apparatus of claim 1, wherein the PSFCH comprises the set of repetitions in the frequency domain, and wherein a number of repetitions associated with the set of repetitions in the frequency domain is equal to a number of scheduled RBs associated with the PSFCH.

12. The apparatus of claim 11, wherein the set of repetitions spans the more than one RBs, and wherein each RB in the more than one RBs is associated with a different cyclic shift.

13. The apparatus of claim 11, wherein the set of repetitions spans the more than one RBs, and wherein each repetition in the set of repetitions is associated with a pseudo-noise (PN) sequence-based scrambling.

14. The apparatus of claim 11, wherein the set of repetitions is associated with one or more interlaced waveforms.

15. The apparatus of claim 14, wherein the one or more interlaced waveforms is associated with one or more cyclic shifts defined based on a higher layer parameter associated with the one or more interlaced waveforms.

16. The apparatus of claim 15, wherein the one or more cyclic shifts is defined further based on a parameter based on the number of scheduled RBs associated with the PSFCH.

17. The apparatus of claim 15, wherein the one or more cyclic shifts are associated with a root sequence change.

18. The apparatus of claim 11, wherein a resource pool is defined for each RB of the more than one RBs.

19. The apparatus of claim 11, wherein a single resource pool is defined for all of the more than one RBs.

20. The apparatus of claim 11, wherein a number of cyclic shift pair associated with the PSFCH is based on the number of repetitions associated with the set of repetitions in the frequency domain.

21. The apparatus of claim 1, wherein the PSFCH spans the more than one resource blocks (RBs), and wherein a number associated with the more than one RBs is defined based on a radio resource control (RRC) parameter.

22. The apparatus of claim 1, wherein the PSFCH spans the more than one resource blocks (RBs), and wherein a number associated with the more than one RBs is defined based on a parameter in a sidelink control information (SCI) associated with the PSFCH.

23. The apparatus of claim 1, wherein the PSFCH spans the more than one resource blocks (RBs) with a sequence, and wherein the sequence is generated based on a cyclic shift, a cyclic shift pair index corresponding to a PSFCH resource index associated with the PSFCH.

24. The apparatus of claim 1, further comprising at least one of a transceiver or an antenna coupled to the at least one processor.

25. A method for communication at a first user equipment (UE), comprising:
receiving, from a second UE, a sidelink communication; and
transmitting, to the second UE based on the sidelink communication, a physical sidelink feedback channel (PSFCH), the PSFCH spanning multiple symbols in a time domain, comprising a set of repetitions in a frequency domain, or spanning more than one resource blocks (RBs).

26. The method of claim 25, wherein the PSFCH spans the multiple symbols in the time domain and comprises a second set of repetitions in one slot.

27. The method of claim 26, wherein the PSFCH is associated with a parameter indicating a starting symbol associated with the second set of repetitions.

28. The method of claim 27, wherein a number of PSFCH symbols associated with the PSFCH is two, and the starting symbol associated with the second set of repetitions is a second symbol associated with the PSFCH.

29. The method of claim 27, wherein a number of PSFCH symbols associated with the PSFCH is four or more, and the second set of repetitions comprises one or more one symbol repetitions.

30. The method of claim 25, wherein the PSFCH spans the multiple symbols in the time domain and comprises a second set of repetitions in two or more slots.
